(19) United States
(12) Patent Application Publication
(10) Pub. No.: US 2016/0114841 A1
(43) Pub. Date: Apr. 28, 2016

(54) Elastomeric Track Assembly and Track Band Having Damping Features

(71) Applicant: Soucy International Inc., Drummondville (CA)

(72) Inventors: Maxime GAGNE, St-Francois-Xavier de Brompton (CA); Louis-Frederic MARCHILDON, Drummondville (CA); Charles DEVIN, Windsor (CA); Patrick L'HERAULT, St-Majorique de Grantham (CA)

(21) Appl. No.: 14/920,794

(22) Filed: Oct. 22, 2015

Related U.S. Application Data
(60) Provisional application No. 62/067,020, filed on Oct. 22, 2014.

(51) Int. Cl. B62D 55/24; B62D 55/065; B62D 55/125; B62D 55/14

(52) U.S. Cl. CPC B62D 55/244; B62D 55/14; B62D 55/065; B62D 55/125

(57) ABSTRACT

An elastomeric track assembly and track band having damping features is disclosed. The track comprises several surfaces disposed as to dampen the force of impact. The track is configured to have a ground contacting surface and portion not in contact with the ground. The idler and road wheels where applicable are disposed above a portion of the track that is not primarily in contact with the ground surface in order to prevent alignment between the wheel and the point of impact with the ground surface.

### CROSS-REFERENCE TO RELATED APPLICATIONS

The present patent application claims the benefits of priority of U.S. Provisional Patent Application No. 62/067,020, entitled “Elastomeric track assembly and track band having damping features”, and filed at the United States Trademark and Patent Office on Oct. 22, 2014, the content of which is incorporated herein by reference.

### FIELD OF THE INVENTION

The present invention generally relates to an elastomeric track that is installed on traction assemblies used as wheel replacements for wheeled vehicles. More particularly, the present invention relates to an elastomeric track that comprises damping capabilities allowing the absorption of force coming from the ground or the impact of the track on the ground.

### BACKGROUND OF THE INVENTION

Many recreational vehicles such as snowmobiles and ATVs are provided with track systems for propelling them.

In the case of a snowmobile, the track system forms an integral part of the vehicle and the track system is fully integrated in the overall construction and suspension of the vehicle.

In the case of an ATV (including UTV or SSV), the track systems are often used in replacement of the wheels normally used for propelling the vehicle.

Still, on an ATV, the track system is configured to support and drive an endless track typically, but not necessarily, made from elastomeric material. Hence, the vast majority of track systems comprise at least one drive wheel (e.g. a sprocket wheel), a more or less complex support structure, at least one idler wheel and road wheel.

Generally, in these traction systems, the weight of an ATV is transferred to the track by the road wheels of the traction assembly. Typically the load needs to be transferred to the ground as quickly as possible while stress in the track needs also to be reduced as much as possible to enhance the lifetime of the track. For these reasons, tracks are designed to have profiles located directly under the contacting wheels areas. In such configuration, the load of the wheel applied on the track is directly transferred to the ground through the outer profiles located directly under the contacting wheel areas and in contact with the ground (vertical alignment of the wheels and outer profiles in contact with the ground.)

ATV are often used and operated in off-road environments where they encounter hard and/or immovable obstacles such as rocks, roots, etc. When the track systems of these vehicles encounter such obstacles, they must overcome them. However, overcoming hard and/or immovable obstacles generally involves shocks and other vibrations that are transmitted to the vehicle and ultimately to its operator.

More particularly on an ATV, the impacts can also results in an involuntary reaction in the steering, depending on the type of obstacles and the area where they touch the tracks.

Having outer profiles positioned directly under the contacting wheels areas does not provide any improvement to such scenario. Indeed, as it transmits the load in the opposite direction, it also transmits the shocks and vibrations.

In the past, many attempts to reduce the transmission of vibration and shocks to the vehicles and its operator have been tried. For instance, in U.S. Patent Application Publication No. 2012/0242141, a track system for use as a wheel replacement on a wheeled vehicle is disclosed. In this track system, the support structure comprises a suspension which allows the track system to absorb some shocks and vibrations.

Still, most past attempts to reduce the transmission of vibrations and shocks to the vehicle and its operator imply bulky or otherwise complex arrangements that add costs and complexity to the track system. Furthermore, these systems do not overcome involuntary reactions in the steering as a result of impact on obstacles or other objects. Hence, there is a need for a track system that can mitigate at least some of the aforementioned shortcomings.

### SUMMARY OF THE INVENTION

Accordingly, one aspect of the present invention the endless track is made of elastomeric materials that generally do not have profiles touching the ground directly under the wheels of the track system where the track is installed and when the load is applied to the track.

The track of the present invention are in general, but not necessarily, installed on a traction assembly. This traction assembly generally comprises a sprocket wheel which is adapted to be mounted to the vehicle, preferably on the wheel hub thereof. The traction assembly also generally comprises a support structure which preferably, but not necessarily, supports idlers wheels and/or road wheels. The track of the present invention is generally, but not necessarily, disposed around and cooperates with the sprocket wheel, the support structure and, if any, the idler and/or road wheels.

The endless track of the present invention comprises an inner wheel-engaging surface and an outer ground-engaging surface. The inner wheel engaging surface comprises at least two longitudinally extending areas where the wheels will engage the track. The outer ground-engaging surface, which is provided with a plurality of traction lug profiles, further defines at least three laterally extending portions extending along the circumference of the track that can be separated in two groups: laterally extending portions in contact with the ground on hard surface, and laterally extending portions not in contact with the ground on hard surface. In accordance with the present invention, the wheel engaging areas (more particularly, the center of the wheel) are located in the laterally extending portions not in contact with the ground on a hard surface when the load is applied on the track.

Consequently, when a vehicle equipped with a traction assembly equipped with a track of the present invention is ridden over a hard surface such as, but not limited to, concrete or pavement, only laterally extending portions with higher traction lugs of the endless track will effectively engage the ground. On this type of surface, a track with the contacting wheel areas aligned with a laterally extending portion with lower tractions lugs not in contact with the ground can't directly transfer the load to the ground. To go there the ground, the load transmitted by the wheels needs to travel laterally in the track to reach a portion where there are traction lugs in contact with the ground.

According to one aspect of the present invention, the load by being overhanged by laterally extending portions with higher traction lugs out of the wheel contacting area, similar to a cantilever beam, generally creates a deformation in the track. In addition to this deformation, the load is away from the ground in a vertical way.

According to one aspect of the present invention, the mechanism of the track system is similar to that of a complete suspension system. In a typical suspension, an ATV for example, the wheel is the item in contact with the ground and the load is the ATV itself. As for the track in accordance with the principle of the present invention, the load is not vertically aligned with the point of contact to the ground. As such the load has to travel laterally to reach that point. The suspension is the laterally element that allow the load to be transmit to the wheels. The specific configuration of the track of the present invention plays that role. Also, by not having the load and the point of contact to the ground aligned, the inertia needs to be considered. All these features and configuration works together as a damper/shock absorber when the track hits an obstacle.

When looking at an ATV hitting an obstacle, more likely a wheel of the ATV, we can see the wheel going up much higher than the ATV frame. This effect is caused by the suspension between the wheel and the ATV frame, in other words, the point of contact to the ground and the load. When hitting an obstacle, the inertia of the ATV (load) wants to keep the ATV at his original height, but oppositely, the wheel that hits the obstacle needs to go up. To reduce the opposite effect of both components, the suspension absorb the impact before it reach the ATV, to allow the inertia to keep the ATV at is position.

The endless track of the present invention works the same way. When the track hits an obstacle, laterally extending portions of the lug profiles with higher traction lugs are more likely to be the one hitting the obstacle and going up. The road wheels of the ATV conversion system carries the load, so much more inertia forces the ATV to stay at its original position. In this case, the track needs to play the role of the suspension to allow both elements to work together. A feature of the present invention is to not have a profile under the wheels in a way that allows the hitting point to be located vertically under the wheel. Having an impact vertically in alignment with the wheels will result in no damping effect due to the direct transfer of the impact to the wheel of the track assembly. Consequently, one aspect of the present invention is a track band, also referred as an endless track, wherein the lug profile under the wheel contact area is different from the ground impacting area as to require the force of impact to be directed through the track as to have a damping effect, thus reducing the force of impact transferred to the wheels, and to the ATV.

According to another aspect of the present invention, when a vehicle having the disclosed track assembly and track band is ridden over a soft surface, such as, but not limited to, snow, mud or sand, all the traction lugs of the track will generally engage the ground since the higher traction lugs will at least partially penetrate the soft surface, thereby allowing the smaller traction lugs to also engage the ground. In this situation, no or very little traction and/or flotation will be lost because every profiles and the total width of the track will be in contact with the ground.

According to another aspect of the present invention, the track is mounted on a traction assembly comprising a sprocket wheel which is adapted to be mounted to the vehicle, preferably on the wheel hub thereof, a support structure which preferably, but not necessarily, supports idlers wheels and/or road wheels, the track being disposed around and cooperates with the sprocket wheel, the support structure and, if any, the idler and/or road wheels, the endless track comprising an inner wheel-engaging surface and an outer ground-engaging surface, the inner wheel engaging surface comprises at least two longitudinally extending areas where the wheels will engage the track, the outer ground-engaging surface, which is provided with a plurality of traction lug profiles, further defines at least three laterally extending portions extending along the circumference of the track that can be separated in two groups: laterally extending portions in contact with the ground on hard ground, and laterally extending portions not normally in contact with the ground on hard ground wherein the center of the wheel engaging areas are located in laterally extending portions not normally in contact with the ground on hard surface when the load is applied on the track.

According to one aspect of the present invention, the track band may be reinforced with stiffening rods.

According to one aspect of the present invention, the track band may comprise openings in the track used for driving the track.

According to one aspect of the present invention, the track band driving lugs are used to drive the track.

According to one aspect of the present invention, the center of the wheel engaging areas of the track system is aligned with the center of the wheel.

According to one aspect of the present invention, at least 50% of the wheel engaging area is located in laterally extending portions not normally in contact with the ground on hard surface. According to another aspect of the present invention the wheel engaging areas have a width up to twice the width of the wheel.

In one aspect of the present invention, it is provided an endless track for a track assembly, the track assembly comprising a supporting frame, a sprocket wheel pivotally mounted to the supporting frame, idler wheels pivotally mounted to the supporting frame, and road wheels pivotally mounted to the supporting frame. The endless track further comprises an inner wheel-engaging surface and an outer ground-engaging surface. The outer ground-engaging surface comprises traction lugs located along a circumference of the endless track defining a central portion and at least two lateral portions, wherein an average thickness of the lateral portions is inferior to an average thickness of the central portion, and wherein at least half of a wheel contacting area is in contact with the inner wheel-engaging surface corresponding to the lateral portions whereby rigidity of the lateral portions allows a damping effect.

The endless track may further comprise widthwise reinforcing stiffeners.

The sprocket wheel may further comprise teeth and the endless track may further comprise apertures to be engaged by the said teeth.

In another aspect of the invention, the wheel contacting area may be fully in contact with the inner wheel-engaging surface corresponding to the lateral portions. In a further aspect of the invention, thin and flexible traction lugs may be connected to the lateral portions.

Furthermore, the widthwise center of the inner wheel-engaging surface may be aligned with the widthwise center of the wheels.

In further aspects of the invention, the thickness of the lateral portions may be variable along a transversal direction of the endless track or the variation of the thickness of the lateral portions may be linear.

In further aspects of the invention, the thickness of the central portion may be variable along a transversal direction of the endless track or the central portion may be punctual in a lateral direction.

In yet another aspect of the present invention, the inner wheel-engaging surface may comprise lugs adapted for engaging the driving wheel and for guiding the road and idler wheels.

The invention is further directed to a method of manufacturing an endless track as defined herein above.

The invention is also further directed to a vehicle equipped with a plurality of endless tracks as defined herein above.

The invention is yet further directed to an endless track for a track assembly, the track assembly comprising a supporting frame, a sprocket wheel pivotally mounted to the supporting frame, idler wheels pivotally mounted to the supporting frame, and road wheels pivotally mounted to the supporting frame. The endless track comprises an inner wheel-engaging surface, an outer ground-engaging surface, and widthwise reinforcing stiffeners. The outer ground-engaging surface comprises traction lugs located along a circumference of the endless track defining a central portion and at least two lateral portions, shape of the lateral portions being different than shape of the central portion, and wherein at least half of a wheel contacting area is in contact with the inner wheel-engaging surface corresponding to the lateral portions whereby a rigidity of the lateral portions allows a damping effect.

The invention is also yet further directed to a vehicle equipped with a plurality of endless tracks as defined herein above.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a side view of a traction assembly for an ATV where the track in accordance with the present invention can be used.

FIG. 2 is a side view of a track in accordance with the present invention.

FIG. 3 is a bottom view of a track in accordance with the present invention.

FIG. 4 is a top view of a track in accordance with the present invention.

FIG. 5 is a front cross-sectional view of a track with support wheels, in accordance with the present invention.

FIG. 6 is a comparison between a typically ATV suspension and the track of the present invention.

FIG. 7 is a front cross-sectional view of a prior art track with support wheels.

FIG. 8 is a top view of another track in accordance with the present invention.

FIG. 9 is a side view of another track in accordance with the present invention.

FIG. 10 is a front cross-sectional view of a track with support wheels, in accordance with the present invention (another possible configuration).

FIG. 11 is a front partial cross-sectional view of a track with support wheels, in accordance with the present invention (another possible configuration).

FIG. 12 is a front partial cross-sectional view of a track with support wheels, in accordance with the present invention (another possible configuration).

FIG. 13 is a front partial cross-sectional view of a track with support wheels, in accordance with the present invention (another possible configuration).

FIG. 14 is a front partial cross-sectional view of a track with support wheels, in accordance with the present invention (another possible configuration).

FIG. 15 is a schematic view of the shape of the cross section of another embodiment of a track band to illustrate the ground contacts.

FIG. 16 is a schematic view of the shape of the cross section of another embodiment of a track band to illustrate the ground contacts.

FIG. 17 is a top view of another track in accordance with the present invention.

FIG. 18 is a front partial cross-sectional view of a track with support wheels, in accordance with the present invention (another possible configuration).

### DETAILED DESCRIPTION OF THE PREFERRED EMBODIMENT

A novel elastomeric track with damping features will be described hereinafter. Although the invention is described in terms of specific illustrative embodiments, it is to be understood that the embodiments described herein are by way of example only and that the scope of the invention is not intended to be limited thereby.

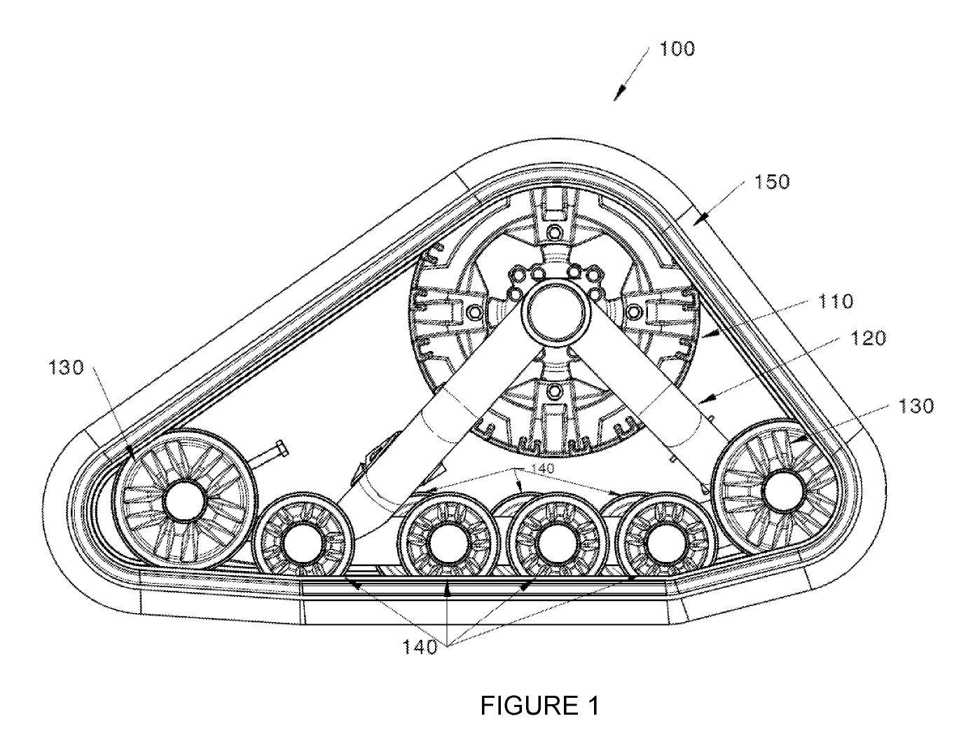

Now referring to FIG. 1, in the present embodiment, it is shown a traction assembly 100, where a track system can be installed, generally comprising a sprocket wheel 110 adapted to be fixedly mounted to the wheel hub or axle which is generally operationally connected to the suspension and/or steering system of a vehicle (not shown). The traction assembly 100 also comprises a supporting frame structure 120 to which idler wheels 130 and road wheels 140 are preferably mounted. The idlers wheels 130 are preferably respectively mounted at the fore and at the aft of the supporting frame 120 while the road wheels 140 are generally mounted along the frame 120, between the front and rear idler wheels 130. The track assembly has a longitudinally extending endless track 150 preferably made from reinforced elastomeric material disposed around the sprocket wheel 110, the idler wheels 130, the road wheels 140, and the supporting frame 120.

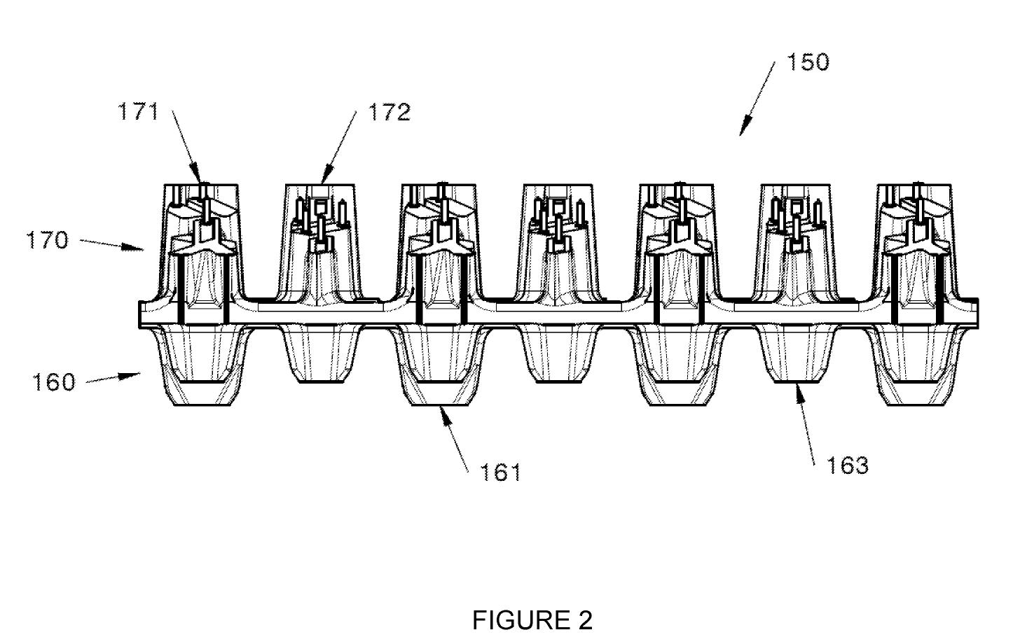

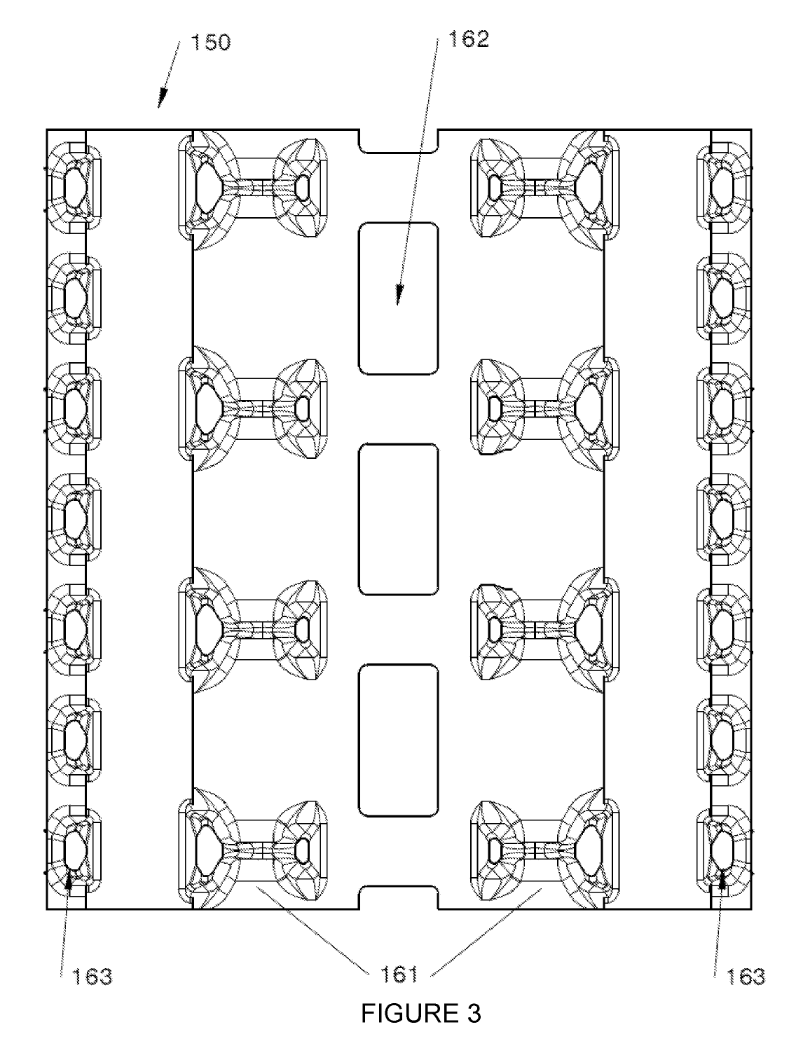

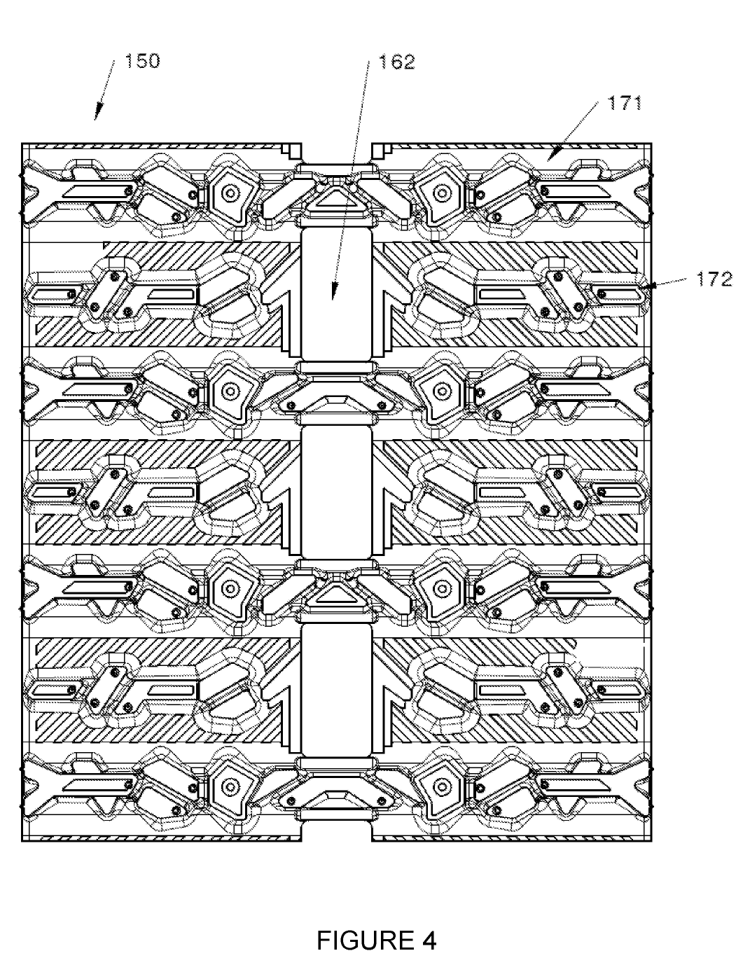

Referring now to FIGS. 2, 3 and 4, in the present embodiment, the endless track 150 generally defines an inner wheel-engaging surface 160 and an outer ground-engaging surface 170. The inner wheel-engaging surface 160 is preferably provided with guide lugs 161 and 163 which are adapted to guide the endless track 150 and to prevent lateral movement thereof. The endless track 150 may be provided with a least one row of longitudinally aligned holes 162 adapted to be engaged by the sprocket wheel 110.

Understandably, the present configuration should only be viewed as one of many possible configurations.

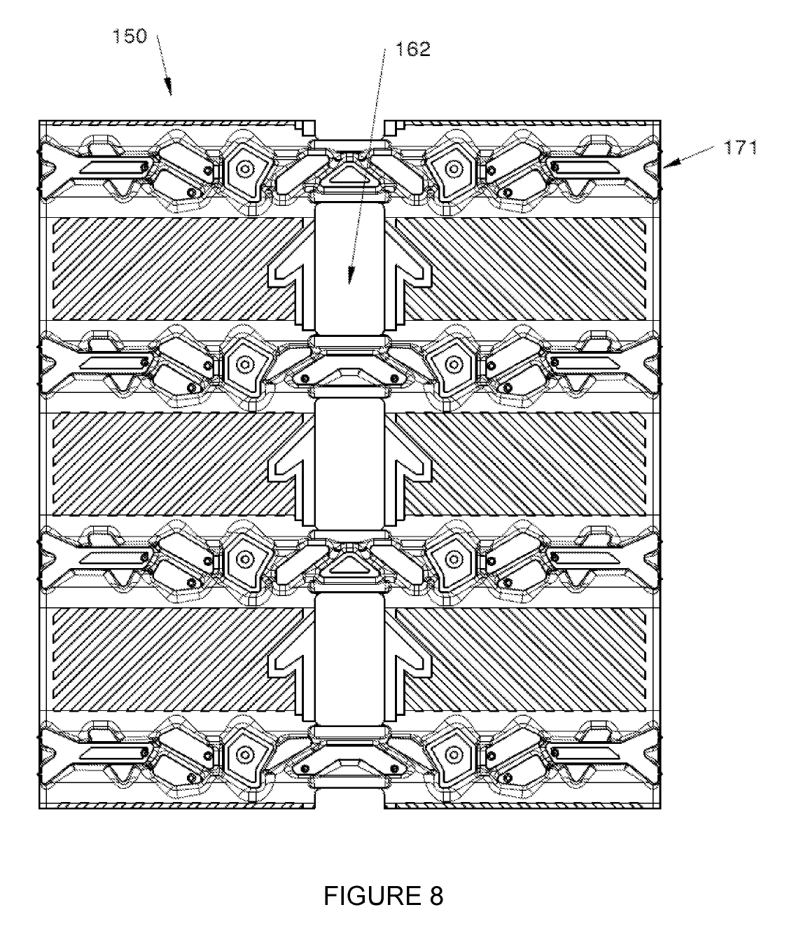

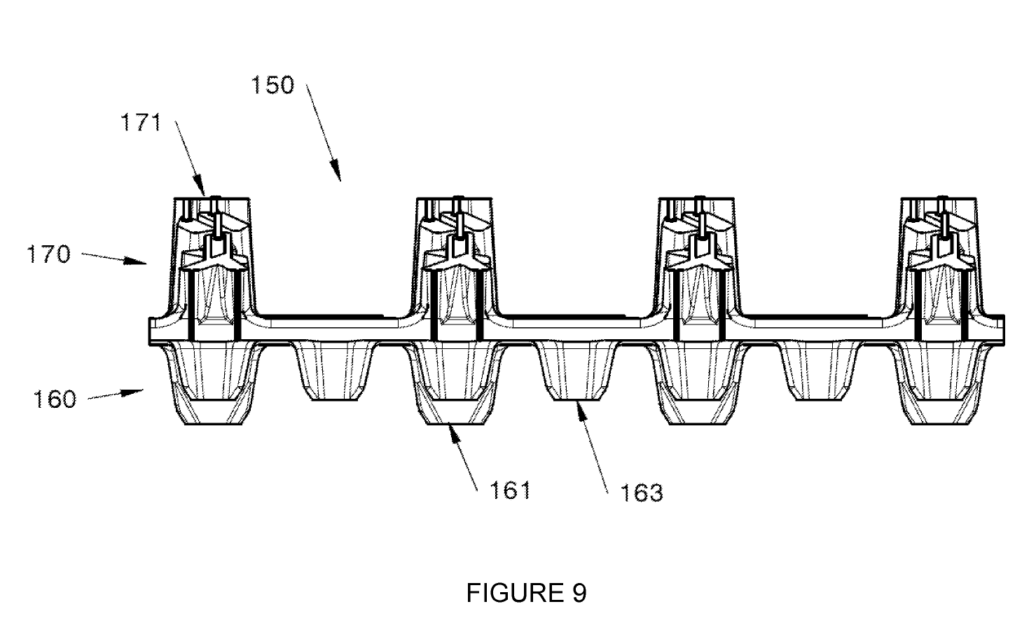

Still referring to FIGS. 2, 3 and 4, the ground-engaging surface 170 is provided with a plurality of generally laterally extending tractions lug profiles 171 and 172 which are disposed along the circumference of the track 150. Other possible configurations are shown on FIGS. 8 and 9.

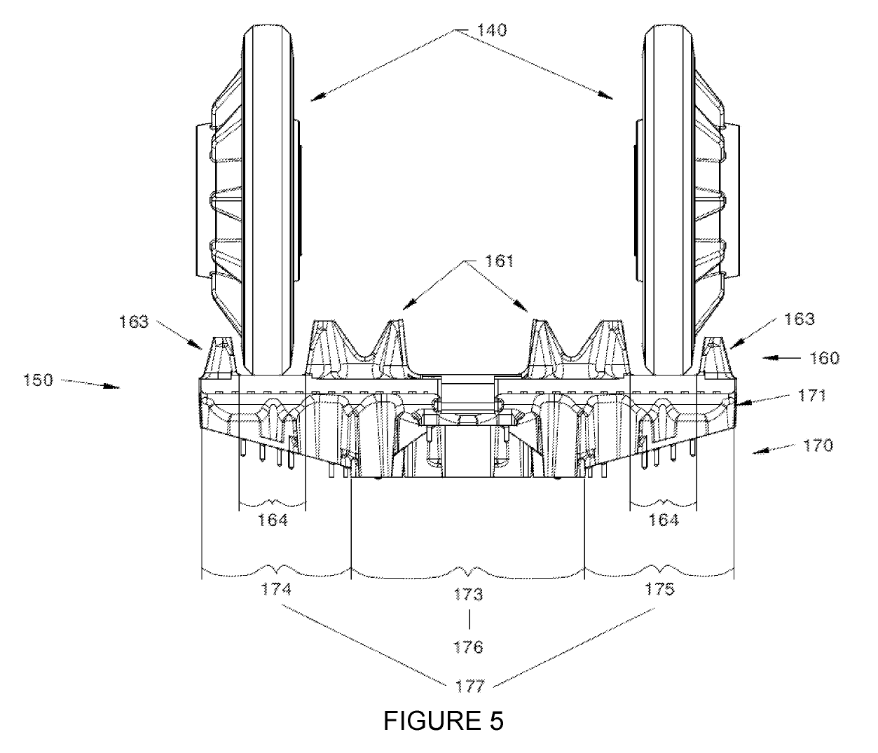

Now referring to FIG. 5, the endless track 150 of the present invention comprises an inner wheel-engaging surface 160 and an outer ground-engaging surface 170. The inner wheel engaging surface comprises at least two longitudinally extending areas 164 where the road wheels 140 will generally engage the track 150. The outer ground-engaging surface 170, which is provided with a plurality of traction lug profiles 171, further defines at least three laterally extending portions 173, 174, 175 extending along the circumference of the track. The laterally extending portions can be separate in 2 groups: laterally extending portions in contact with the ground—176—on hard surfaces, and laterally extending portions not in contact with the ground—177—on hard surfaces. In accordance with the present invention, center of the wheel engaging areas 164 is located in laterally extending portions 177 not in contact with the ground.

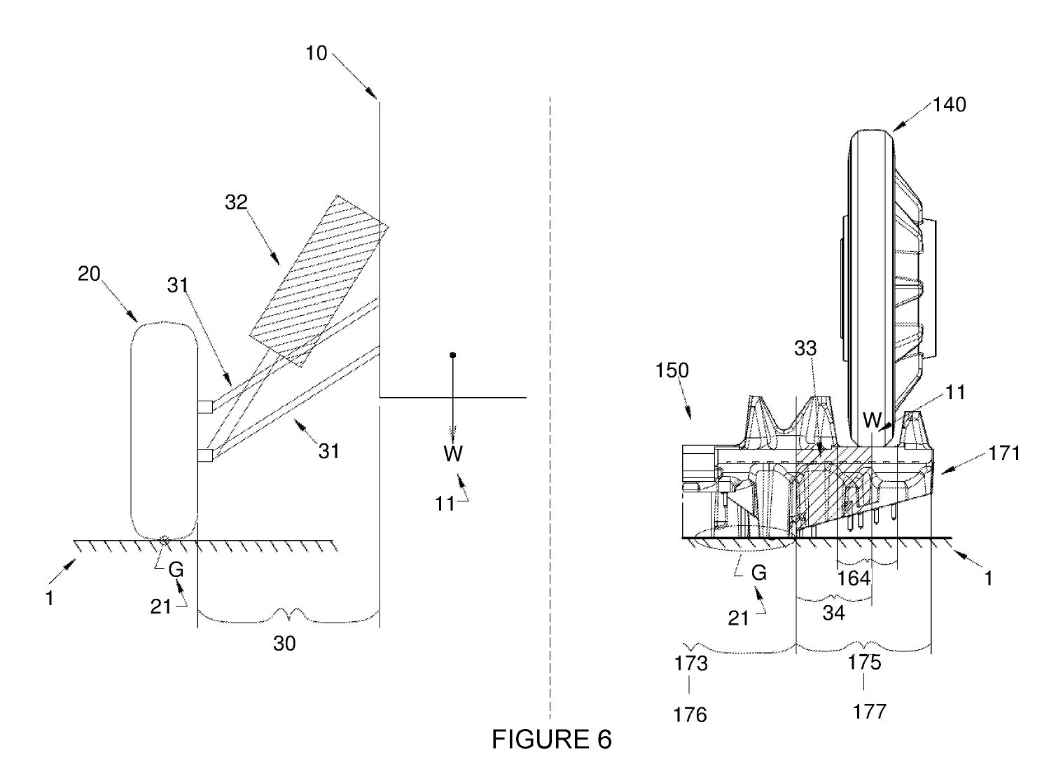

Now referring to FIG. 6 in the present embodiment, the track 150 can be compare to a suspension of an ATV. The ATV suspension system typically comprise the ATV 10, the wheel 20 and the suspension 30, which further comprise the suspension arms 31 and the damper 32.

Still referring to FIG. 6, according to the present embodiment, the load 11 of the ATV 10 is not aligned with the point of contact 21 on the ground 1. The track 150 of the present embodiment has features similar to the features required to create a suspension system. As such, the load 11 is transmitted by the wheel 140. Consequently, the profiles 171 are in contact with the ground 1 while the load 11 and point of contact 21 on the ground 1 are not aligned. Between these two points, the area 34 is the equivalent of the suspension 30 of a typical suspension system and the track portion 33 is the equivalent of the damper 32.

Consequently, an ATV equipped with a traction assembly 100 having the track of the present embodiment 150, when encountering an obstacle on or off the road, will react in a way similar to a suspension system. As such, the portion 176 will generally be the portion hitting the obstacle. The impact will then be transmitted to the wheel 140 while passing through the damping area 34 thus reducing the amount of force transmitted to the vehicle.

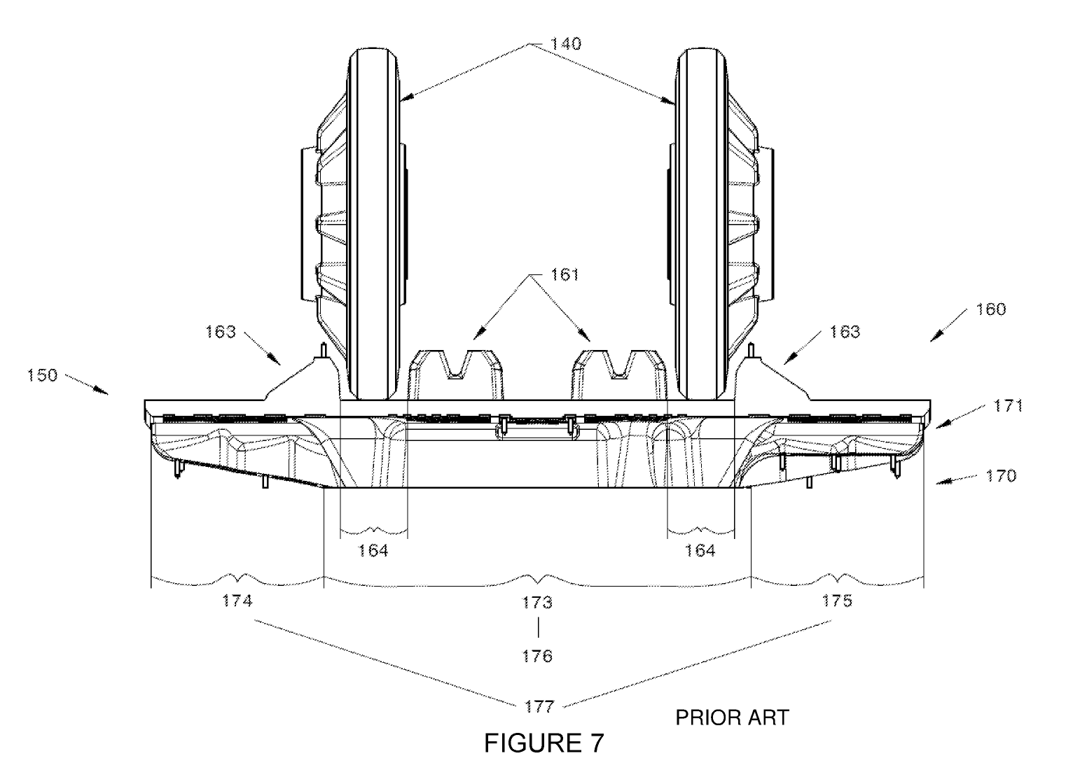

Now referring to FIG. 7 illustrating a prior art endless track 150 having similar features as the track of the present embodiment but lacking the damping effect. In such prior art embodiment, the centers of the wheel engaging areas 164 are not aligned with the laterally extending areas 177 which correspond to the areas typically not in contact with the ground on hard surface. The wheel engaging areas are thus located in the laterally extending areas in contact 176 with the ground on such hard surfaces. As a result of this type of configuration, the impact transmitted to the wheel 140 resulting from an impact with an obstacle on the ground has a direct way to the wheel 140 and is not required to travel laterally in the track to reach the ground. Therefore, the damping effect of the track 150 according to the present embodiment typically generated by the overhanging of the load compare with the ground contacting area, is not present in the prior art endless track configuration.

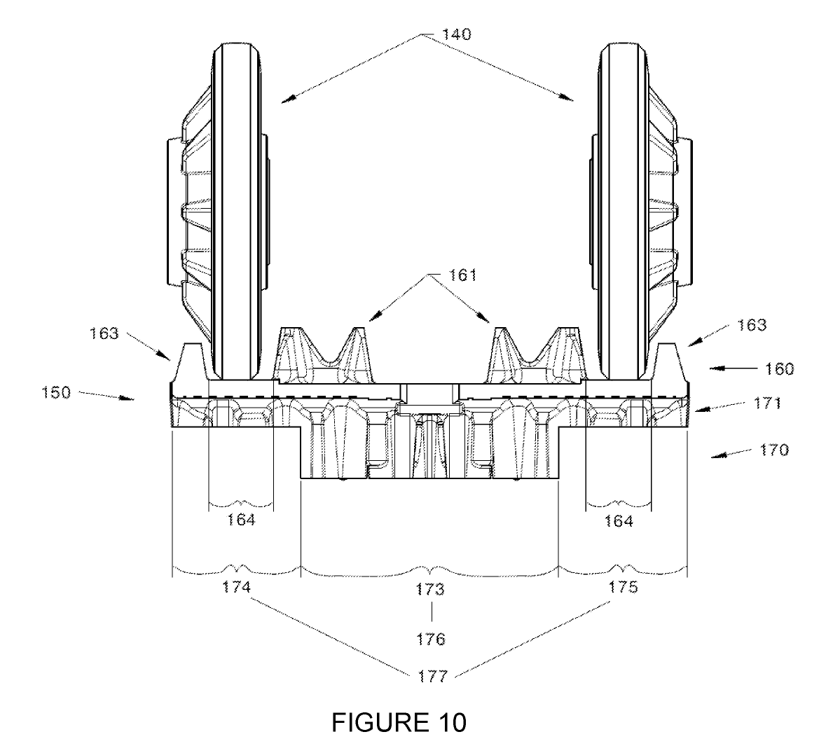

Now referring to FIG. 10, in this other embodiment, another configuration of the endless track 150 of the present invention is shown. In this embodiment, the laterally extending areas 174 and 175 are flat instead of being at an angle. The centers of the wheel engaging areas are still in the laterally extending areas 177, thus not in contact with the ground on hard surfaces.

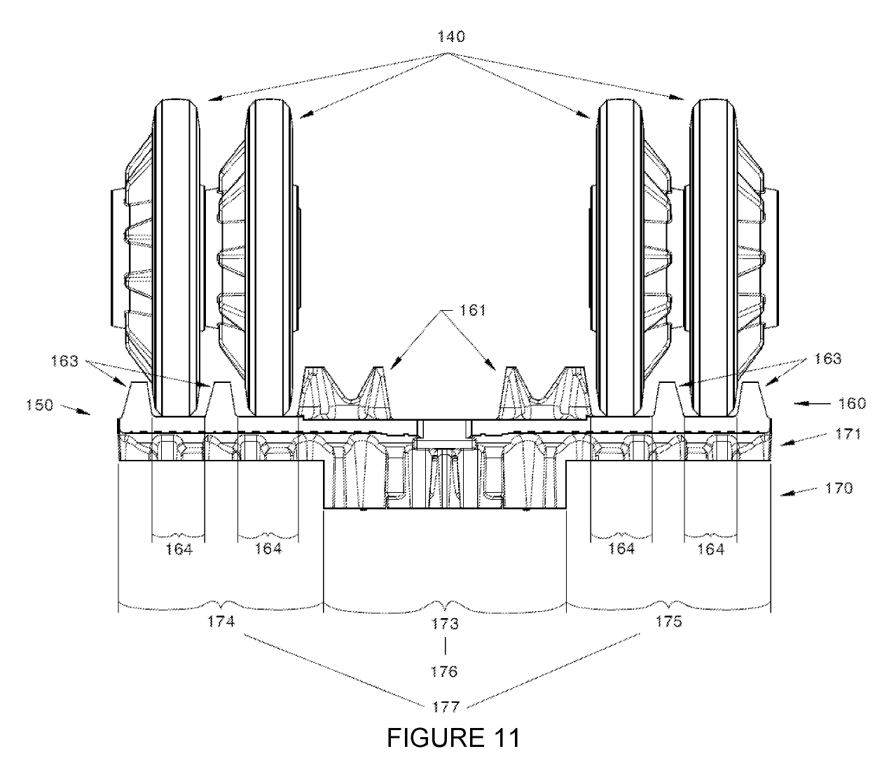

Now referring to FIG. 11 in yet another embodiment of the present invention, another configuration of the endless track 150 is shown. In this embodiment, the laterally extending areas 174 and 175 are flat instead of being at an angle and 4 wheels 140 are engaging the track in the wheel engaging areas 164. The centers of the wheel engaging areas 164 are still in the laterally extending areas 177, thus not in contact with the ground on hard surfaces.

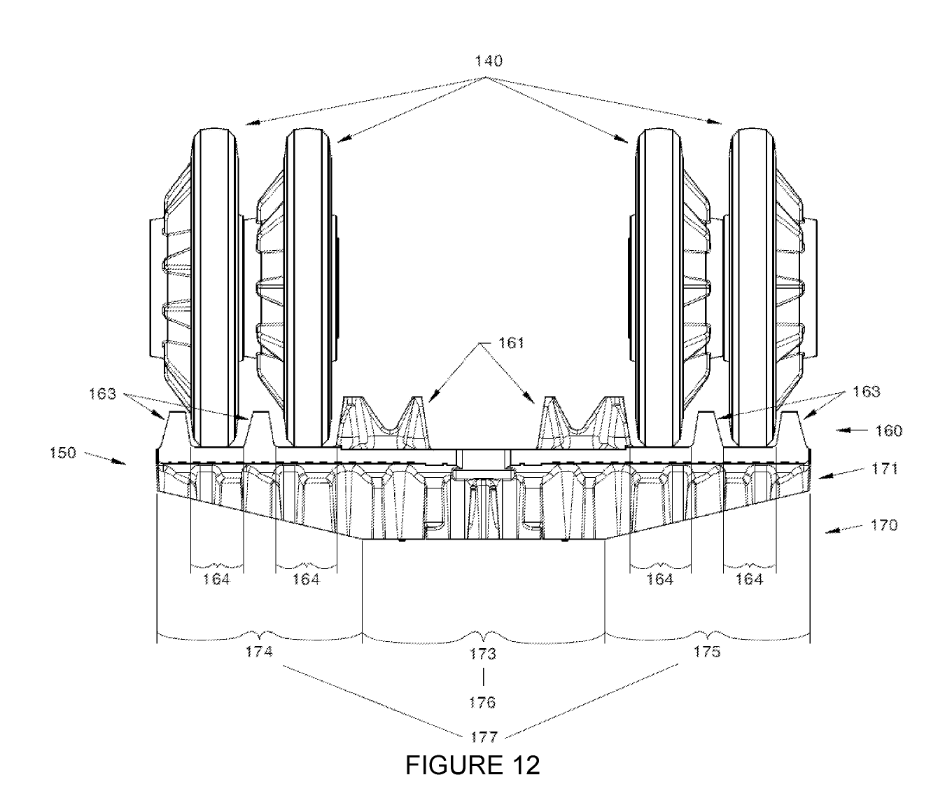

Now referring to FIG. 12 in yet another embodiment of the present invention, another configuration of the endless track 150 is shown. In this embodiment, four wheels 140 are engaging the track 150 in the wheel engaging areas 164. The centers of the wheel engaging areas 164 are still in the laterally extending areas 177, thus also not in contact with the ground on hard surfaces.

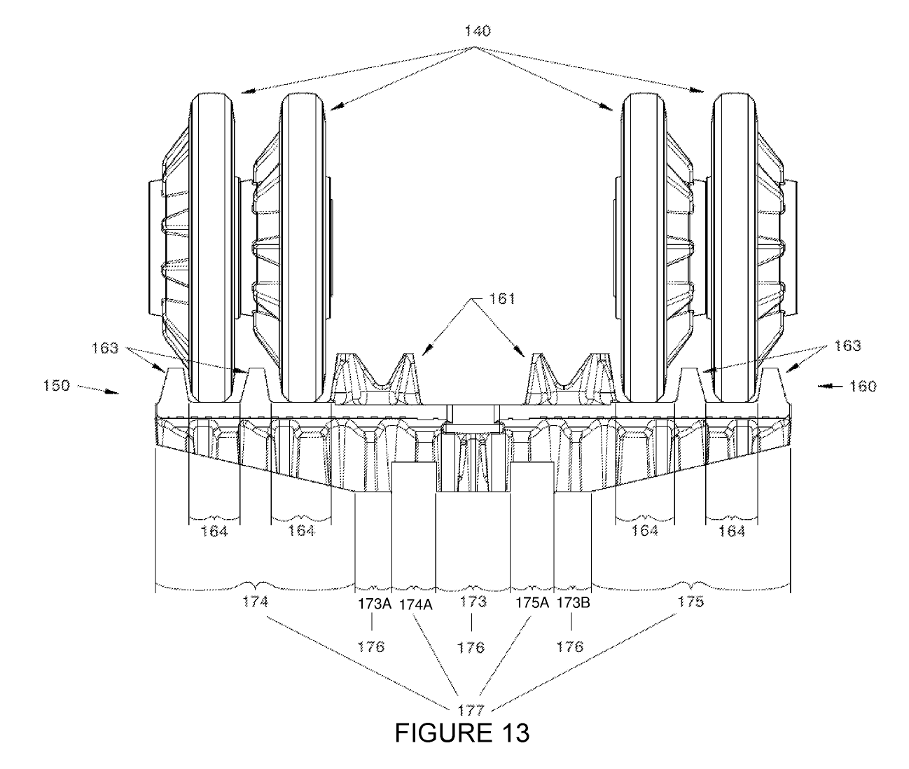

Now referring to FIG. 13 in yet another embodiment of the present invention another configuration of the endless track 150 is shown. In this embodiment, four wheels 140 are engaging the track in the wheel engaging areas 164. There are 7 laterally extending areas 174, 174A, 173, 173A, 173B, 175, 175A that can also be divided in 2 groups: laterally extending portions in contact with the ground—176—on hard surfaces, and laterally extending portions not in contact with the ground—177—on hard surfaces. The centers of the wheel engaging areas 164 are still in the laterally extending areas 177, thus not in contact with the ground on hard surfaces.

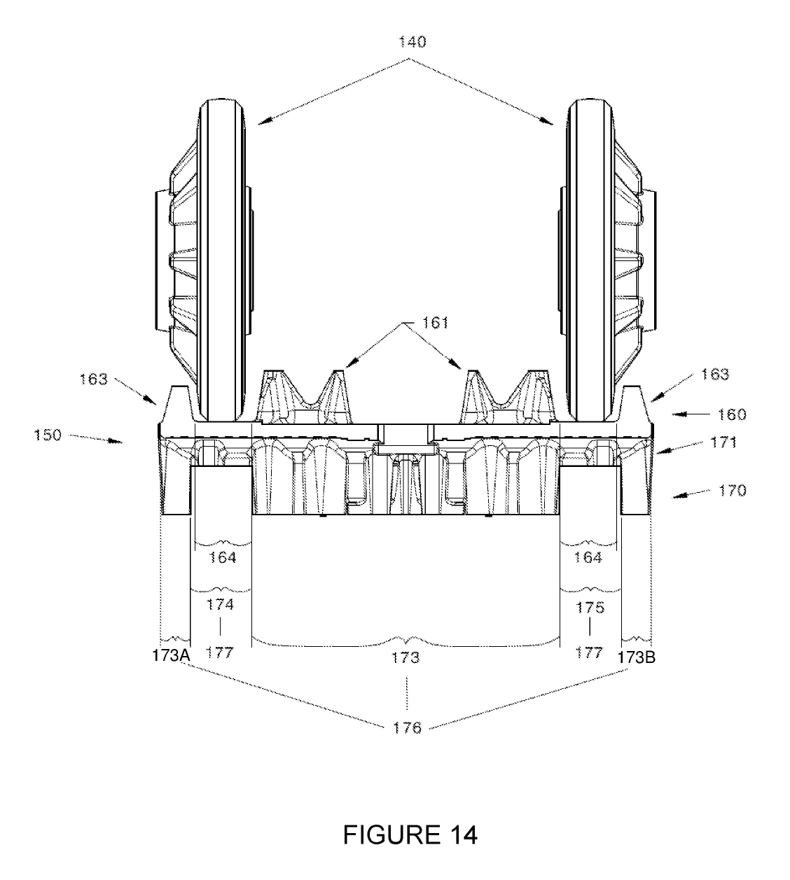

Now referring to FIG. 14 in yet another embodiment of the present invention another configuration of the endless track 150 in accordance with the present invention is shown. In this embodiment, there are five laterally extending areas 174, 173, 173A, 173B, 175 than can also be divided in two groups: laterally extending portions in contact with the ground—176—on hard surface, and laterally extending portions not in contact with the ground—177—on hard surface. The centers of the wheel engaging areas 164 are still in the laterally extending areas 177 not in contact with the ground on hard surface.

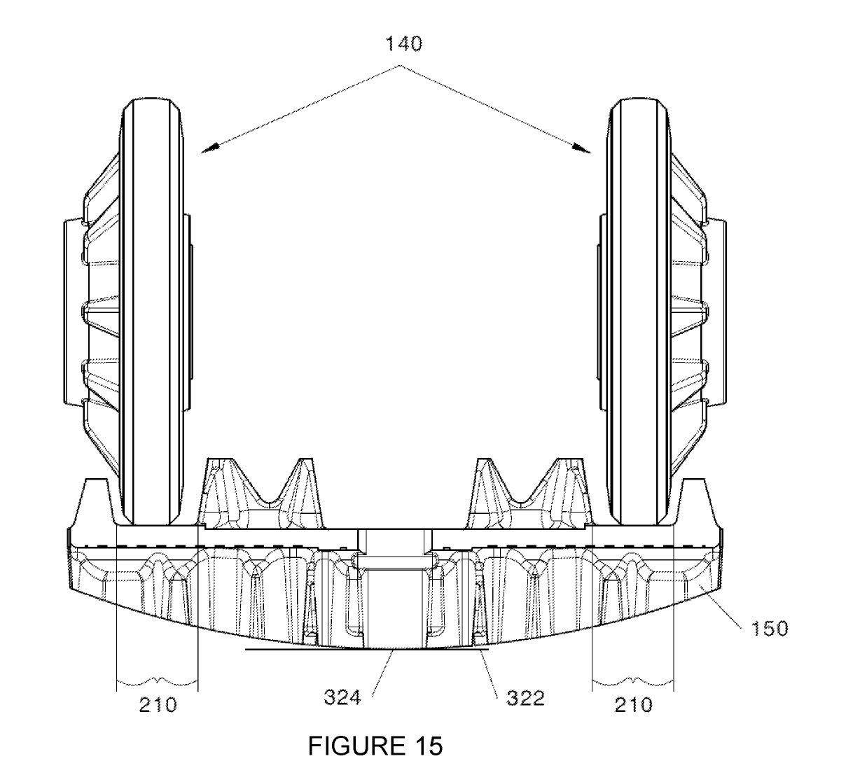

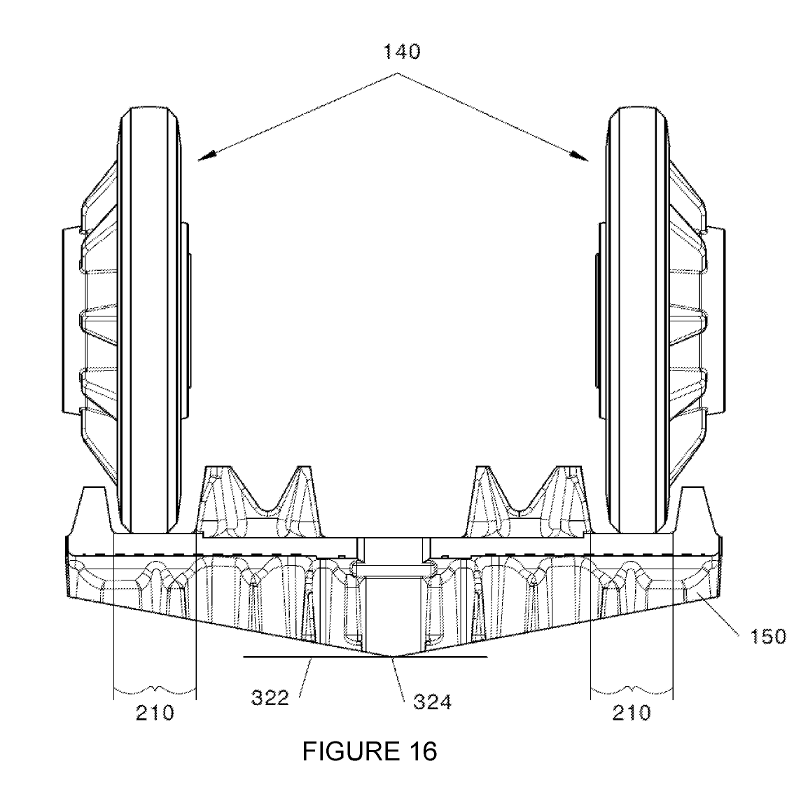

Now referring to FIGS. 15 and 16, according to one embodiment of the present invention, the track has a profile 150 allowing a lateral offset of the force of impact from directly underneath the idler and road wheels. The profile 150 should have a shape that avoids continuous contact with the ground on hard surfaces directly underneath the wheels. In FIGS. 15 and 16, the cross sectional shapes of the tracks 150 are an arc of a circle and a v-shape, respectively as to allow single punctual contact 324 with the ground 322 on hard surfaces. In these types of cases, no ground contact is generally allowed directly on the sections 210 in alignment with the bottom portion of the wheels 140. As such, these track profiles 150 will, upon impact, require the force of impact to laterally travel through the track 150, thus having a damping effect before being directed to the wheel and ultimately to the small vehicle structure itself.

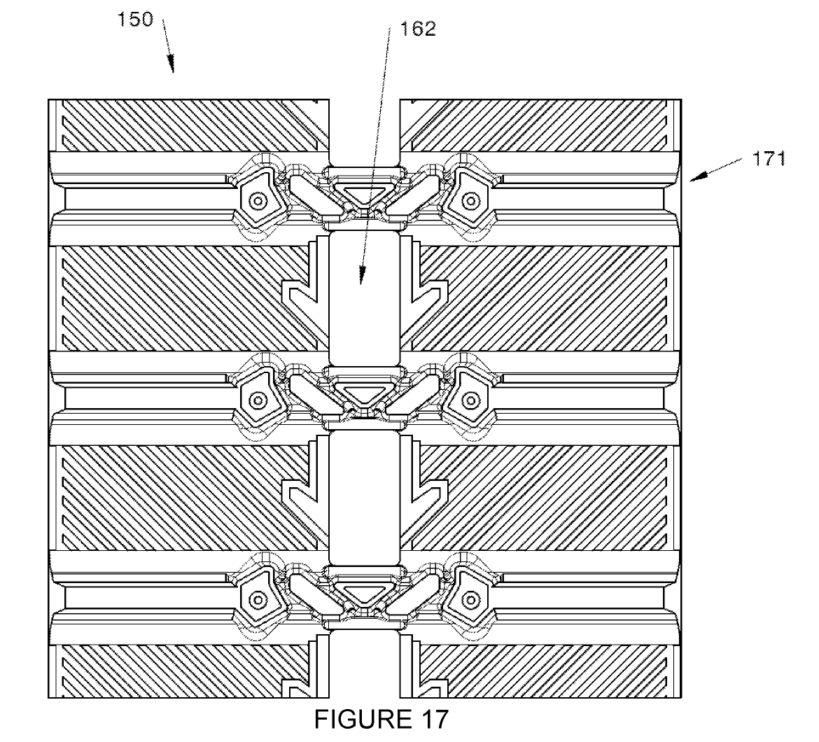

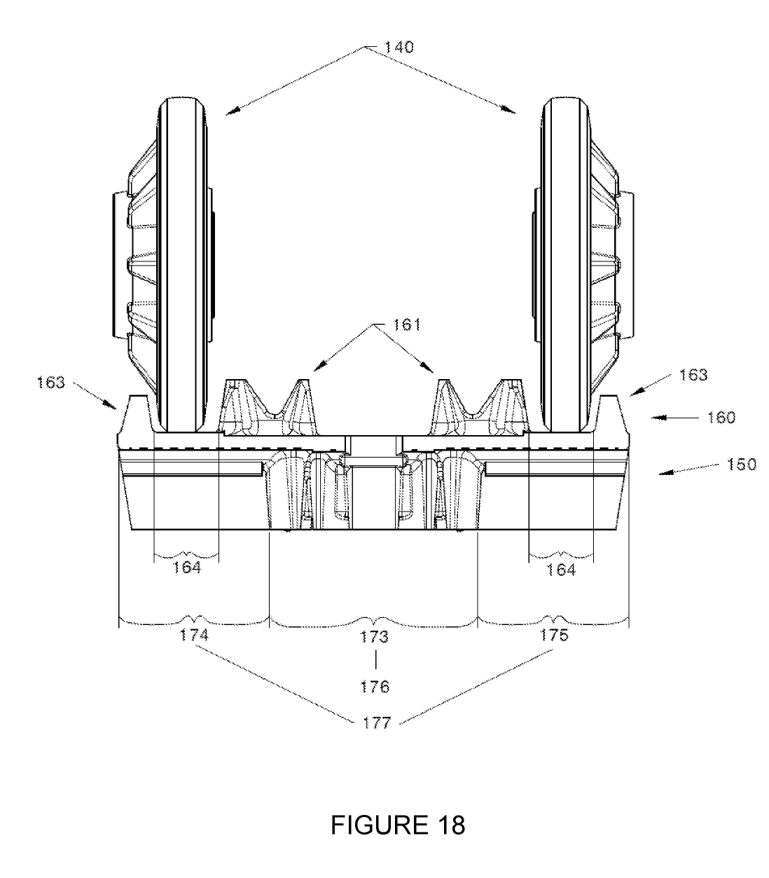

Now referring to FIGS. 17 and 18, in this other embodiment, another configuration of the endless track 150 of the present invention is shown. In this embodiment, the laterally extending areas 174 and 175 are flat instead of being at an angle. Laterally extending areas 174 and 175 are thin and flexible in order to not transfer the load between the ground and wheels. The centers of the wheel engaging areas are still in the laterally extending areas 177, thus do not support the wheels on hard surfaces.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) An endless track for a track assembly, the track assembly comprising:
a supporting frame;
a sprocket wheel pivotally mounted to the supporting frame;
idler wheels pivotally mounted to the supporting frame; and
road wheels pivotally mounted to the supporting frame;
the endless track comprising:
an inner wheel-engaging surface; and
an outer ground-engaging surface;
the outer ground-engaging surface comprising traction lugs located along a circumference of the endless track defining a central portion and at least two lateral portions, wherein an average thickness of the lateral portions is inferior to an average thickness of the central portion, and wherein at least half of a wheel contacting area is in contact with the inner wheel-engaging surface corresponding to the lateral portions whereby rigidity of the lateral portions allows a damping effect.

2) An endless track as claimed in claim 1, the endless track comprising widthwise reinforcing stiffeners.

3) An endless track as claimed in claim 1, the sprocket wheel comprising teeth and the endless track comprising apertures to be engaged by the teeth.

4) An endless track as claimed in claim 1, the wheel contacting area being fully in contact with the inner wheel-engaging surface corresponding to the lateral portions.

5) An endless track as claimed in claim 1, wherein thin and flexible traction lugs are connected to the lateral portions.

6) An endless track as claimed in claim 1, the widthwise center of the inner wheel-engaging surface being aligned with the widthwise center of the wheels.

7) An endless track as claimed in claim 1, the thickness of the lateral portions being variable along a transversal direction of the endless track.

8) An endless track as claimed in claim 7, the variation of the thickness of the lateral portions being linear.

9) An endless track as claimed in claim 1, the thickness of the central portion being variable along a transversal direction of the endless track.

10) An endless track as claimed in claim 1, the central portion being punctual in a lateral direction.

11) An endless track as claimed in claim 1, the inner wheel-engaging surface comprising lugs adapted for engaging the driving wheel and for guiding the road and idler wheels.

12) A method of manufacturing an endless track as defined in claim 1.

13) A vehicle equipped with a plurality of endless tracks as defined in claim 1.

14) An endless track for a track assembly, the track assembly comprising:
a supporting frame;
a sprocket wheel pivotally mounted to the supporting frame;
idler wheels pivotally mounted to the supporting frame; and
road wheels pivotally mounted to the supporting frame;
the endless track comprising:
an inner wheel-engaging surface;
an outer ground-engaging surface; and
widthwise reinforcing stiffeners;
the outer ground-engaging surface comprising traction lugs located along a circumference of the endless track defining a central portion and at least two lateral portions, shape of the lateral portions being different than shape of the central portion, and wherein at least half of a wheel contacting area is in contact with the inner wheel-engaging surface corresponding to the lateral portions whereby a rigidity of the lateral portions allows a damping effect.

15) An endless track as claimed in claim 14, the wheel contacting area being fully in contact with the inner wheel-engaging surface corresponding to the lateral portions.

16) An endless track as claimed in claim 14, the widthwise center of the inner wheel-engaging surface being aligned with the widthwise center of the wheels.

17) An endless track as claimed in claim 14, the thickness of the lateral portions being variable along a transversal direction of the endless track.

18) A vehicle equipped with a plurality of endless tracks as defined in claim 14.
